(19) United States
(12) Patent Application Publication
(10) Pub. No.: US 2018/0270575 A1
(43) Pub. Date: Sep. 20, 2018

(54) CONTENT PLAYBACK DEVICE, METHOD, AND CONTENT PLAYBACK SYSTEM

(71) Applicant: YAMAHA CORPORATION, Hamamatsu-shi (JP)

(72) Inventor: Tomoyoshi AKUTAGAWA, Hamamatsu-shi (JP)

(21) Appl. No.: 15/904,930

(22) Filed: Feb. 26, 2018

Related U.S. Application Data
(63) Continuation of application No. PCT/JP2017/010948, filed on Mar. 17, 2017.

(51) Int. Cl. H04R 3/12; H04L 29/06; G06F 3/16

(52) U.S. Cl. CPC H04R 3/12; G06F 3/165; H04L 65/60

(57) ABSTRACT

A method includes causing a first content playback device to acquire device identification information of a second content playback device, causing the first content playback device to transmit a state control command to switch the second content playback device between an inactive state and an active state to the second content playback device, using the device identification information, when the first content playback device switches between an inactive state and an active state, and forming a link state so that the first content playback device, which is a master device, distributes content data to the second content playback device, which is a client device, and so that the first content playback device and the second content playback device collaboratively play back content.

### CROSS-REFERENCE TO RELATED APPLICATION

This application is bypass continuation of international patent application PCT/JP2017/010948, filed on Mar. 17, 2017, designating the United State of America, the entire disclosure of which is incorporated herein by reference.

### BACKGROUND OF THE INVENTION

### 1. Field of the Invention

The present invention relates to a content playback device, a method, and a content playback system.

### 2. Description of the Related Art

JP2015-533441 discloses that a plurality of audio players forma group for collaboratively playing back common audio content.

### SUMMARY OF THE INVENTION

Incidentally, if a master-client relationship is set among a plurality of content playback devices that form a link state for collaboratively playing back content, it is convenient to be able to switch a client device into an active state, linked with a master device.

In view of the foregoing problem, an object of the invention is to provide a content playback device, a method, and a content playback system such that the state of a client device can be switched, linked with a master device.

According to one aspect of the present invention, there is provided a content playback device including: a link state forming unit which forms a link state so that a content playback device that is a master device distributes content data to another content playback device that is a client device and so that the content playback device and the another content playback device collaboratively play back content; an identification information acquisition unit which acquires device identification information of the another content playback device; and a command transmission unit which transmits a state control command to switch the another content playback device between an inactive state and an active state to the another content playback device, using the device identification information, when the content playback device switches between an inactive state and an active state.

In the above-mentioned aspects of the invention, the another content playback device includes one or a plurality of content playback units that can individually switch between an inactive state and an active state, and the command transmission unit transmits the state control command for a content playback unit selected from the one or plurality of content playback units, to the another content playback device.

In the above-mentioned aspects of the invention, the command transmission unit transmits, to the another content playback device, a playback unit status confirmation command for inquiring about whether each of the content playback units is able to form the link state or not, and transmits the state control command for a content playback unit that is able to form the link state, to the another content playback device.

In the above-mentioned aspects of the invention, the command transmission unit transmits, to the another content playback device, a number-of-playback-units confirmation command for inquiring about a number of the content playback units of the another content playback device, and transmits the playback unit status confirmation command for each of the content playback units, to the another content playback device.

In the above-mentioned aspects of the invention, the content playback device further including: first and second content playback units which can individually switch between an inactive state and an active state; and a state switching unit which switches the second content playback unit between an inactive state and an active state when the first content playback unit switches between an active state and an active state, if a setting for the first content playback unit and the second content playback unit to collaboratively play back content is given.

In the above-mentioned aspects of the invention, a switching can be made between a first setting in which only the content playback device switches between an inactive state and an active state, and a second setting in which the state control command is transmitted to the another content playback device when the content playback device switches between an inactive state and an active state.

In the above-mentioned aspects of the invention, a first command to switch only the content playback device between an inactive state and an active state, or a second command to transmit the state control command to the another content playback device when the content playback device switches between an inactive state and an active state is accepted from a command generation unit which selectively generates the first command or the second command according to a manner of operation of a power button.

In the above-mentioned aspects of the invention, the content playback device further including the command generation unit.

In the above-mentioned aspects of the invention, the content playback device and the another content playback device simultaneously play back common content.

According to another aspect of the present invention, there is provided a method including: causing a first content playback device to acquire device identification information of a second content playback device; causing the first content playback device to transmit a state control command to switch the second content playback device between an inactive state and an active state to the second content playback device, using the device identification information, when the first content playback device switches between an inactive state and an active state; and forming a link state so that the first content playback device, which is a master device, distributes content data to the second content playback device, which is a client device, and so that the first content playback device and the second content playback device collaboratively play back content.

In the above-mentioned aspects of the invention, the second content playback device includes one or a plurality of content playback units that can individually switch between an inactive state and an active state, and the transmitting includes transmitting the state control command for a content playback unit selected from the one or plurality of content playback units, to the second content playback device.

In the above-mentioned aspects of the invention, the transmitting includes: transmitting, to the second content playback device, a playback unit status confirmation command for inquiring about whether each of the content playback units is able to form the link state or not; and transmitting the state control command for a content playback unit that is able to form the link state, to the second content playback device.

In the above-mentioned aspects of the invention, the transmitting includes: transmitting, to the second content playback device, a number-of-playback-units confirmation command for inquiring about a number of the content playback units of the second content playback device; and transmitting the playback unit status confirmation command for each of the content playback units, to the second content playback device.

In the above-mentioned aspects of the invention, the first content playback device includes first and second content playback units which can individually switch between an inactive state and an active state, and the method further includes switching the second content playback unit between an inactive state and an active state when the first content playback unit switches between an active state and an active state, if a setting for the first content playback unit and the second content playback unit to collaboratively play back content is given.

In the above-mentioned aspects of the invention, a switching can be made between a first setting in which only the first content playback device switches between an inactive state and an active state, and a second setting in which the state control command is transmitted to the second content playback device when the first content playback device switches between an inactive state and an active state.

In the above-mentioned aspects of the invention, the first content playback device accepts a first command to switch only the first content playback device between an inactive state and an active state, or a second command to transmit the state control command to the second content playback device when the first content playback device switches between an inactive state and an active state from a command generation unit which selectively generates the first command or the second command according to a manner of operation of a power button.

In the above-mentioned aspects of the invention, the first content playback device includes the command generation unit.

In the above-mentioned aspects of the invention, the first content playback device and the second content playback device simultaneously play back common content.

According to another aspect of the present invention, there is provided a content playback method includes forming a link state so that a first content playback device, which is one component of a content playback system and a master device, distributes content data to a second content playback device, which is one component of the content playback system and a client device, and so that the first content playback device and the second content playback device collaboratively play back content, and causing the first content playback device to transmit, to the second content playback device, a state control command to switch a state of the second content playback device between an inactive state and an active state when a state of the first content playback device switches between an inactive state and an active state.

In the above-mentioned aspects of the invention, the content playback method further includes causing an identification information acquisition unit, which is one component of the first content playback device, to acquire device identification information of the second content playback device, and causing the command transmission unit to transmit the state control command to the second content playback device, using the device identification information.

According to the invention, the state of a client device can be switched, linked with a master machine.

### BRIEF DESCRIPTION OF THE DRAWINGS

FIG. 1 shows an example of the configuration of a content playback system according to an embodiment.

FIG. 2 shows an example of the configuration of a content playback device according to the embodiment.

FIG. 3 is a front view schematically showing the appearance of a playback device.

FIG. 4 shows an example of a client list held by a master device.

FIG. 5 shows an example of a management table held by a client device.

FIG. 6 shows a management table held by a master device.

FIG. 7 shows examples of commands transmitted from a master device to a client device.

FIG. 8 shows an example of processing to implement a method according to the embodiment.

FIG. 9 is a continuation of FIG. 8.

FIG. 10 shows an example of processing to set a client state link setting.

FIG. 11 shows an example of display on a setting screen.

FIG. 12 shows an example of processing to output a client state link command.

### DETAILED DESCRIPTION OF THE INVENTION

An embodiment of the invention will be described with reference to the drawings.

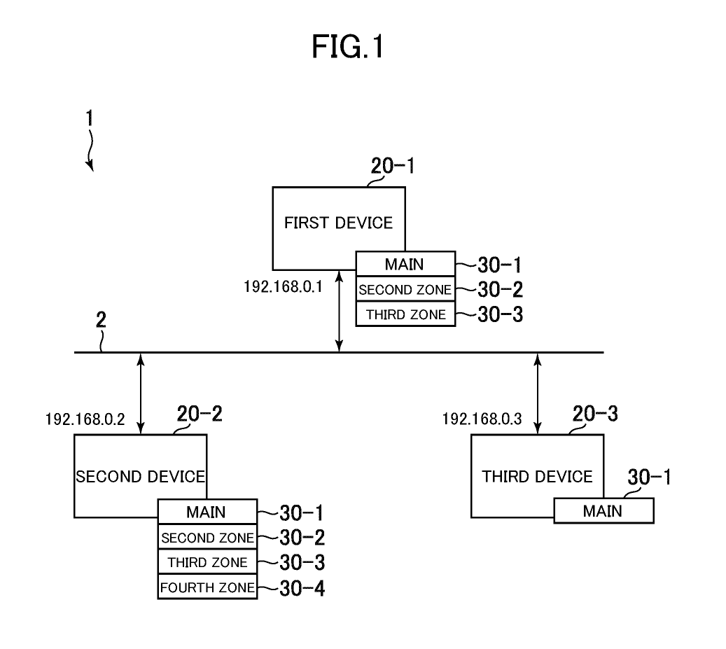

FIG. 1 shows an example of the configuration of a content playback system 1 according to the embodiment. The content playback system 1 includes a first device 20-1, a second device 20-2, and a third device 20-3 as content playback devices. In the description below, the first device 20-1, the second device 20-2, and the third device 20-3 may be described with a general term “device 20”.

The device 20 is connected to a LAN (local area network) 2. The LAN 2 may be a wired LAN or wireless LAN. In the example of FIG. 1, an IP address “198.168.0.1” is set for the first device 20-1. An IP address “198.168.0.2” is set for the second device 20-2. An IP address “198.168.0.3” is set for the third device 20-3.

The device 20 is an audio device or audio-visual device, for example, an AV receiver, AV amplifier, speaker, optical disc playback device (compact disc player, Blu-ray disc (trademark registered) player, DVD (trademark registered) player or the like), or a television receiver or the like. While three devices 20 are shown in the example of FIG. 1, the number of devices 20 may be four or more, or two or fewer.

In the content playback system 1, a plurality of device 20 forma link state for collaboratively playing back content. In the link state, one device 20 which is a master device distributes content data to another or a plurality of other devices 20 which are client devices. These devices 20 can collaboratively play back content. That is, the master device is a device which distributes content data in collaborative playback. The client device is a device which receives content data in collaborative playback. The collaborative playback refers to, for example, a concept including synchronized playback. Playback by one device and playback by another device may be temporally linked with each other but need not be perfectly temporally coincident. In the example of FIG. 1, the first device 20-1 is set as a master device, and the second device 20-2 and the third device 20-3 are set as client devices, thus forming a link state.

The device 20 has a main playback unit 30-1 as a content playback unit. The device 20 may also have one or a plurality of zone playback units 30-2 to 30-4 as separate content playback units from the main playback unit 30-1. In the example of FIG. 1, the first device 20-1 has a main playback unit 30-1 and two zone playback units 30-2, 30-3. The second device 20-2 has a main playback unit 30-1 and three zone playback units 30-2 to 30-4. The third device 20-3 has only a main playback unit 30-1 and has no zone playback units. In the description below, the main playback unit 30-1 and the zone playback units 30-2 to 30-4 may be described with a general term “content playback unit 30”.

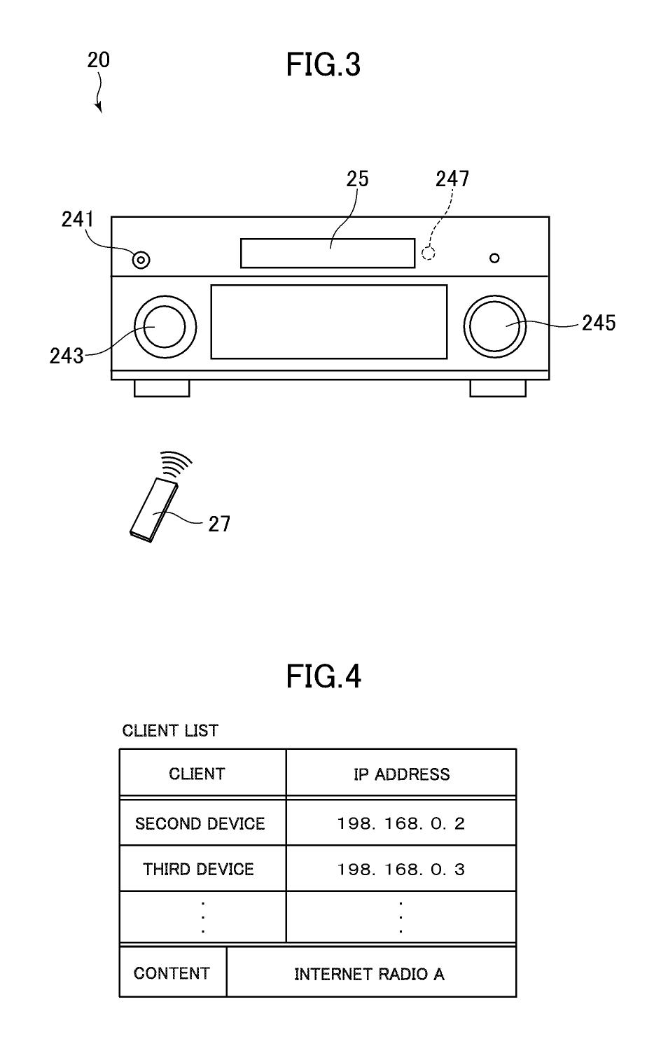

The device 20 can be switched between a standby state (inactive state) and a normal state (active state). The standby state is a state where power consumption is less than in the normal state. In the standby state, power supply is not completely off. Even in the standby state, a network communication function or the like is enabled, making it possible to receive a command, execute a command, or transmit a command. When a power button 241 or a remote controller 27 (see FIG. 3), described later, is operated, or when a state control command (see FIG. 7) for controlling the power supply state, described later, is received from outside, the device 20 switches from the standby state to the normal state. Alternatively, the device 20 switches from the normal state to the standby state.

The one or plurality of content playback units 30 included in the device 20 can individually switch between a standby state (inactive state) and a normal state (active state). In the standby state, the content playback unit 30 is unable to playback content. In the normal state, the content playback unit 30 can play back content. The state of the device 20 and the state of the main playback unit 30-1 may be linked with each other. For example, when the device 20 switches from the standby state to the normal state, the main playback unit 30-1 may switch state similarly.

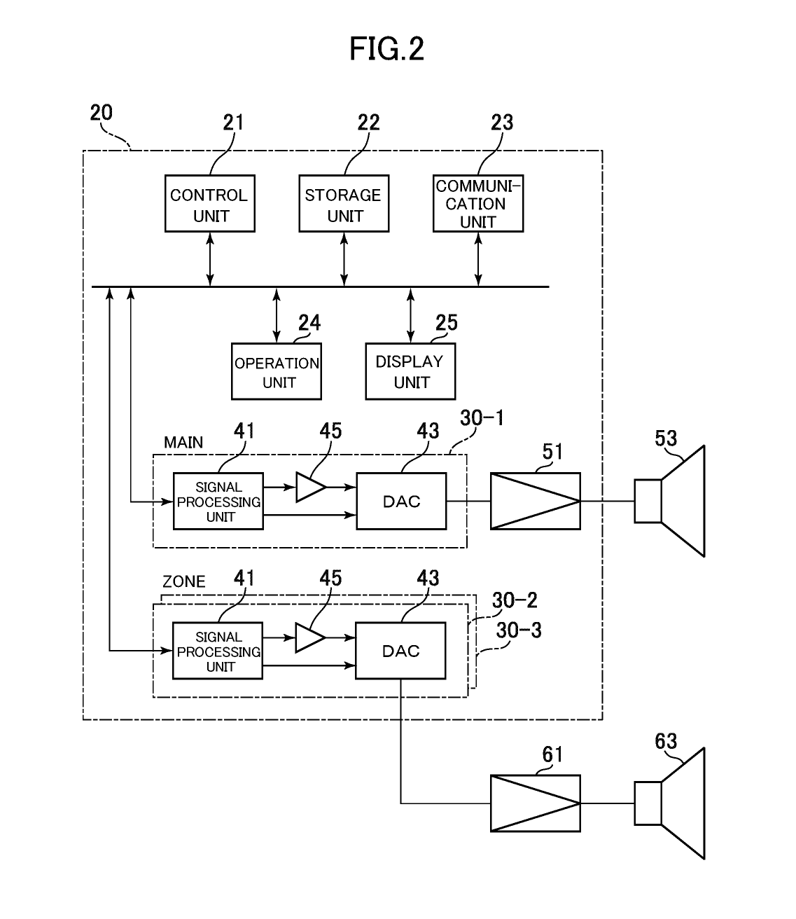

FIG. 2 is a block diagram showing an example of the configuration of the device 20. The device 20 has a control unit 21, a storage unit 22, a communication unit 23, an operation unit 24, and a display unit 25, in addition to the main playback unit 30-1 and the zone playback units 30-2 to 30-4.

The control unit 21 includes at least one microprocessor (CPU) and executes processing according to a program stored in the storage unit 22. The storage unit 22 includes a main storage unit (for example, a RAM) and an auxiliary storage unit (for example, a non-volatile semiconductor memory, hard disk drive, or solid state drive). The storage unit 22 is for storing a program and data. The communication unit 23 is for transmitting and receiving data to and from other devices.

The device 20 may also have a component (for example, an optical disc drive or memory card slot or the like) for reading a program and data stored in an information storage medium (for example, an optical disc or memory card or the like). The program may be supplied to the device 20 via the information storage medium. The program may also be supplied to the device 20 via the internet 6.

The operation unit 24 is for operating the device 20. In the example of FIG. 3, a power button 241 for controlling power supply, an input knob 243 for switching input, and a volume knob 245 for adjusting the volume, or the like, are provided as the operation unit 24 on the front of the device 20. A signal receiving unit 247 which receives infrared remote control signal from a remote controller 27 may also be provided as the operation unit 24. Also, the display unit 25 made up of a liquid crystal display panel may be provided on the front of the device 20.

Each of the content playback units 30 is connected to the control unit 21 or the like in a way that enables communication. In the example of FIG. 2, the main playback unit 30-1 is connected to a speaker 53 via a built-in amplifier 51. The zone playback units 30-2 to 30-4 are connected to a speaker 63 via an external amplifier 61. The external amplifier 61 and the speaker 63 may be installed in a different zone from a zone (for example, a room) where the device 20 is installed). Also, the main playback unit 30-1 may be connected to the speaker 53 via an external amplifier, and the zone playback units 30-2 to 30-4 may be connected to the speaker 63 via a built-in amplifier.

Each of the content playback units 30 has a signal processing unit 41, a DAC (digital-to-analog converter) 43, and a buffer 45. The signal processing unit 41 carries out predetermined signal processing on an audio signal inputted thereto, and outputs the processed audio signal to the DAC 43 without using the buffer 45 or via the buffer 45. The DAC 43 converts an audio signal inputted thereto from a digital signal to an analog signal and outputs the converted audio signal to the built-in amplifier 51 or the external amplifier 61.

Whether to output the audio signal without using the buffer 45 or via the buffer 45 is decided according to whether the device 20 is a master device or a client device. That is, the master device outputs the audio signal via the buffer 45, whereas the client device outputs the audio signal without using the buffer 45. This can cancel a delay in the data distribution from the master device to the client device. Thus, the time difference between the playback of content by the master device and the playback of the content by the client device can be reduced, realizing collaborative playback.

The control unit 21 includes, for example, a host CPU and a network CPU. The network CPU is responsible for a network communication function and the like. When the device 20 is in the standby state, the host CPU is not started up and only the network CPU is started up to carry out network communication or the like. When the power button 241 or the remote controller 27 (see FIG. 3) is operated, or when a state control command (see FIG. 7), described later), is received from outside, the network CPU starts up the host CPU. This causes the device 20 to switch from the standby state to the normal state. Alternatively, the host CPU stops operating and this causes the device 20 to switch from the normal state to the standby state.

The control unit 21, for example, restrains power supply to a selected content playback unit 30 so as to switch the content playback unit 30 to the standby state, and cancels the restraint on power supply so as to switch the content playback unit 30 to the normal state. However, this is not limiting. For example, the control unit 21 may simply prohibit the use of the content playback unit 30 so as to switch the content playback unit 30 to the standby state, and may permit the use so as to switch the content playback unit 30 to the normal state.

FIG. 4 shows an example of a client list held by the first device 20-1, which is the master device. The client list is list information used to form a link state and includes device identification information of the device 20 that is a client device. The device identification information is, for example, an IP address. However, this is not limiting. The device identification information may include, for example, a MAC address. In the example of FIG. 4, the names and IP addresses of the second device 20-2 and the third device 20-3, which are client devices, are described.

The first device 20-1, which is the master device, distributes content data to the second device 20-2 and the third device 20-3, which are client devices, using the IP addresses included in the client list. The first device 20-1, which is the master device, also transmits command (see FIG. 7), described later, to the second device 20-2 and the third device 20-3, which are client devices, using the IP addresses included in the client list.

The control unit 21 of the first device 20-1 reads out the client list saved in the storage unit 22 and acquires the IP addresses of the second device 20-2 and the third device 20-3 (an example of the function of an identification information acquisition unit). The first device 20-1 may also acquire the client list from a terminal such as a smartphone or tablet computer, or may acquire the client list from a server computer on the internet.

The client list may include information of content to be played back in the link state. The content designated in advance in the client list may be, for example, content read out from a compact disc or the like by an optical disc playback device, content saved in a DLNA (Digital Living Network Alliance (trademark registered)) server connected to the LAN 2, or content provided from a content provision server (for example, internet radio or music streaming distribution service or the like) on the internet. In the example of FIG. 4, the playback of internet radio A is designated.

FIG. 5 shows an example of a management table held by the second device 20-2, which is a client device. The management table is table information representing the setting of an input to the content playback unit 30 included in the device 20. Normally, the input to the content playback unit 30 includes, for example, an HDMI (High-Definition Multimedia Interface (trademark registered)) input, an audio input, and a network input (input via the communication unit 23) or the like. The network input includes, for example, a USB input, a Bluetooth (trademark registered) input, and an input from a DLNA server.

If the content playback unit 30 forms a link state with the master device, a value (MC Link) expressing that a link state is to be formed with the master device is set for the input to the content playback unit 30. The content playback unit 30, for which this value is set, plays back content based on content data distributed from the master device.

In the example of FIG. 5, the value (MC Link) expressing that a link state is to be formed with the master device is set for the inputs to the main playback unit 30-1 and the third zone playback unit 30-3. Meanwhile, an HDMI input is set for the input to the second zone playback unit 30-2. An audio input is set for the input to the fourth zone playback unit 30-4.

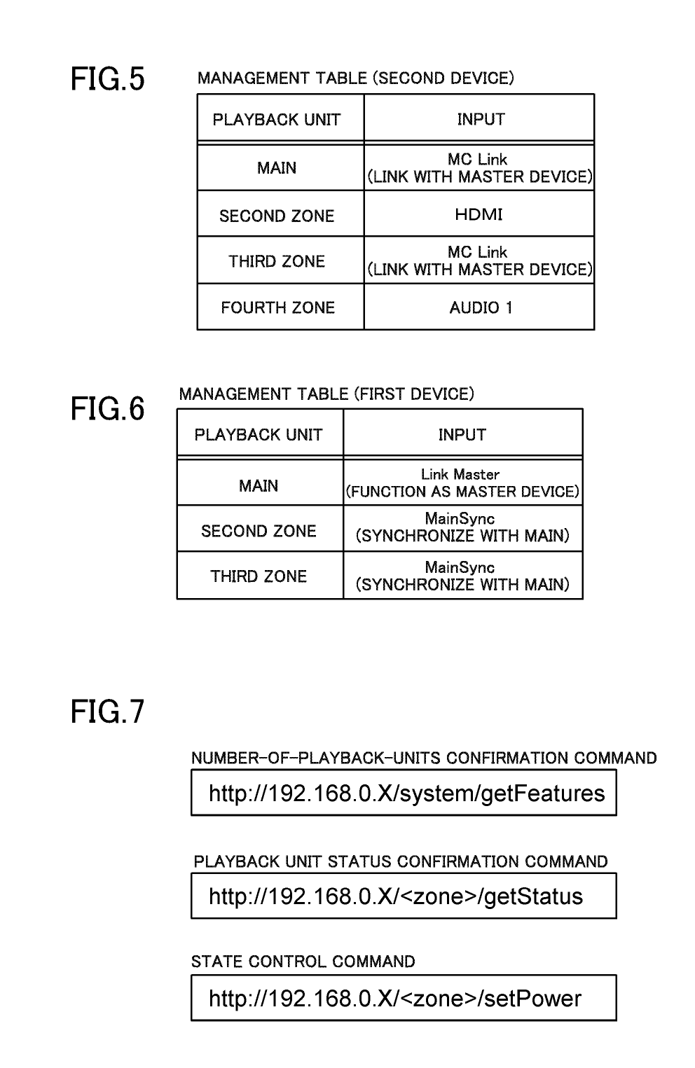

FIG. 6 shows an example of a management table held by the first device 20-1, which is the master device. A value (Link Master) expressing that the device is to function as a master device is set for the main playback unit 30-1. That is, content data of content played back by the main playback unit 30-1, for which this value is set, is distributed to the second device 20-2 and the third device 20-3, which are client devices, for collaborative playback. However, this is not limiting. For example, the value (Link Master) expressing that the device is to function as a master device may be set on one of the zone playback units 30-2, 30-3.

If the zone playback units 30-2, 30-3 synchronize with the main playback unit 30-1, a value (Main Sync) expressing that the unit is to synchronize with the main playback unit 30-1 is set for the inputs to the zone playback units 30-2, 30-3. The zone playback units 30-2, 30-3, for which this value is set, play back content based on content data distributed from the main playback unit 30-1. However, this is not limiting. An output from the main playback unit 30-1 may be used directly as outputs from the zone playback units 30-2, 30-3.

As described above, each of the devices 20 forms a link state based on the setting of the management table held by each device. That is, the control unit 21 of the device 20 reads the management table saved in the storage unit 22 and thus functions as a link state forming unit.

FIG. 7 shows examples of commands transmitted from the first device 20-1, which is the master device, to the second device 20-2 or the third device 20-3, which is a client device. The control unit 21 of the first device 20-1, which is the master device, transmits these commands to the second device 20-2 or the third device 20-3, which is a client device, for example, when switching from the standby state to the normal state (an example of a command transmission unit).

Each of the commands uses the HTTP protocol or the HTTPS protocol and includes a URL as a parameter. The command is transmitted in the form of an HTTP request from the first device 20-1 to the second device 20-2 or the third device 20-3. The second device 20-2 or the third device 20-3, in which an HTTP daemon is started up, accepts an HTTP request with the HTTP daemon and executes processing corresponding to the HTTP request. An HTTP response showing the result of the processing is sent back to the first device 20-1, which is the sender of the command.

A number-of-playback-units confirmation command (getFeatures) is a command for inquiring about the number of content playback units 30 of the device 20. When the first device 20-1 transmits the number-of-playback-units confirmation command to the second device 20-2 or the third device 20-3, the second device 20-2 or the third device 20-3 sends back the number of content playback units 30 (number of zones) of the device itself to the first device 20-1. The number-of-playback-units confirmation command is transmitted in order to specify the content playback unit 30, acquire information, and set a value, in the subsequent two commands. The number-of-playback-units confirmation command may be transmitted not only when the first device 20-1 switches from the standby state to the normal state but also the first time a link state is formed, for example.

A playback unit status confirmation command (getStatus) is a command for inquiring about the status of the input to the each of the content playback units 30 of the device 20. The playback unit status confirmation command is generated for each of the content playback units 30 (a value for selecting a content playback unit 30 is inserted in <zone> in the command). When the first device 20-1 transmits the playback unit status confirmation command to the second device 20-2 or the third device 20-3, the second device 20-2 or the third device 20-3 refers to the management table (see FIG. 5) held by the device itself and sends back the value expressing the input to the selected content playback unit 30, to the first device 20-1.

In other words, the playback unit status confirmation command is a command for inquiring about whether each of the content playback units 30 of the device 20 is able to forma link state or not. Being able to form a link state means that the value (MC Link) expressing that a link state is to be formed with the master device is set in the management table (see FIG. 5). The first device 20-1 transmits the playback unit status confirmation command and thus grasps which of the content playback units 30 of the second device 20-2 and the third device 20-3 is to form a link state as a client device.

A state control command (setPower) is a command for switching the state of the device 20 from the standby state to the normal state. The state control command is generated for a selected content playback unit 30 (a value for selecting a content playback unit 30 is inserted in <zone> in the command). The first device 20-1 transmits, to the second device 20-2 or the third device 20-3, the state control command for a content playback unit 30 which is able to form a link state, of the content playback units 30 of the second device 20-2 and the third device 20-3. The second device 20-2 or the third device 20-3 starts up the host CPU, switches itself from the standby state to the normal state, and switches the selected content playback unit 30 from the standby state to the normal state.

The state control command (setPower) is also a command for switching the state of the device 20 from the normal state to the standby state. When the first device 20-1 transmits the state control command for switching from the normal state to the standby state to the second device 20-2 or the third device 20-3, the second device 20-2 or the third device 20-3 stops the operation of the host CPU and switches itself from the normal state to the standby state.

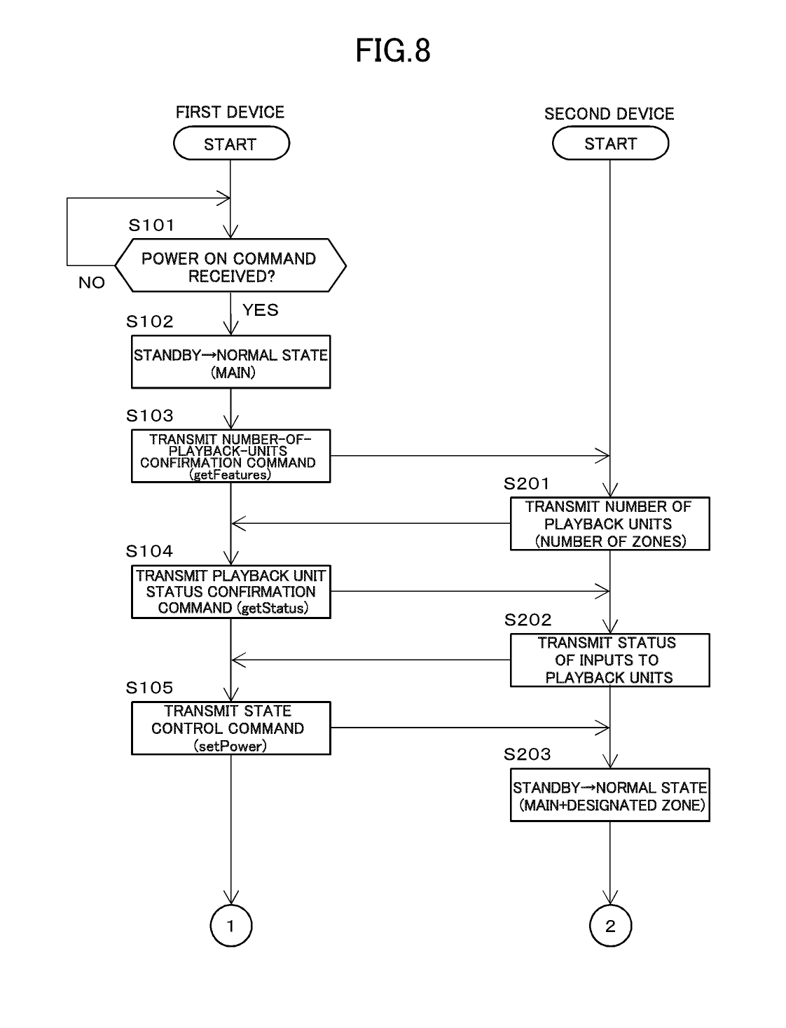

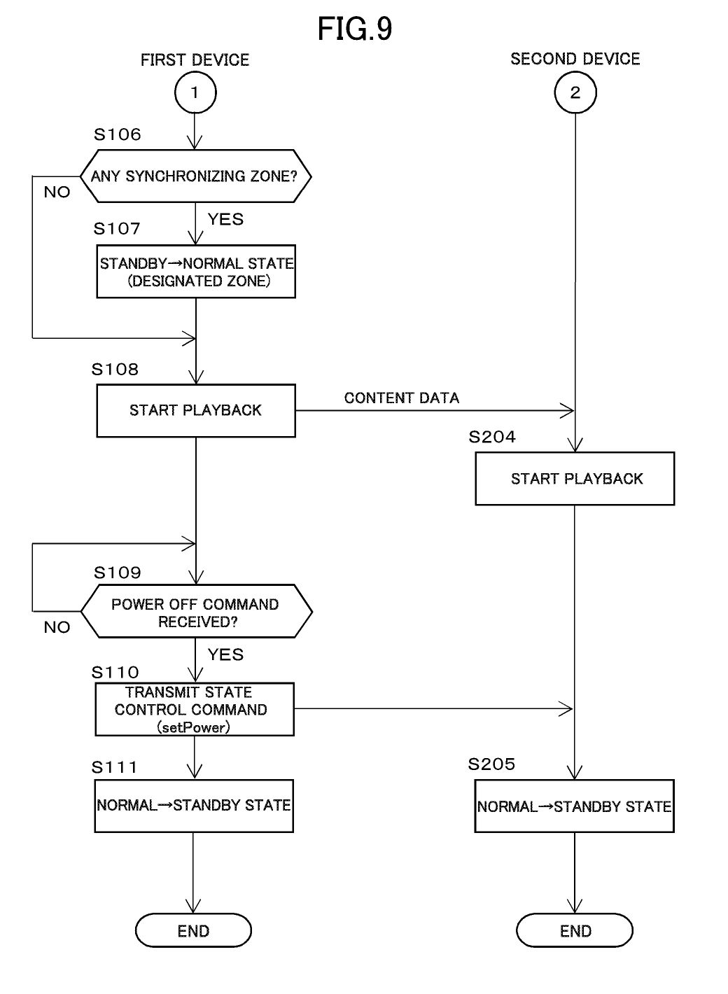

FIGS. 8 and 9 show an example of processing to implement the method according to the embodiment. The processing shown in FIGS. 8 and 9 is implemented by the control unit 21 in each of the first device 20-1 and the second device 20-2 executing a program stored in the storage unit 22. While processing based on the communication between the first device 20-1 and the second device 20-2 is shown in FIGS. 8 and 9, processing based on the communication between the first device 20-1 and the third device 20-3 is carried out similarly.

It is assumed that, before executing the processing shown in FIGS. 8 and 9, the first device 20-1, which is the master device, and the second device 20-2, which is a client device, have already formed a link state and are in the standby state. That these devices have formed a link state means that the value (Link Master) expressing that the device is to function as a master device is set in the management table (see FIG. 6) of the first device 20-1, which is the master device, and that the value (MC Link) expressing that a link state is to be formed with the master device is set in the management table (see FIG. 5) of the second device 20-2, which is a client device.

It is also assumed that, in the first device 20-1, which is the master device, a setting to link the state of a client device when the first device 20-1 switches between the standby state and the normal state in response to a power on command or a power off command (client state link setting) is enabled. Details of the client state link setting will be described later. Meanwhile, it is assumed that, in the second device 20-2, which is a client device, a setting to switch between the standby state and the normal state in response to a state control command (setPower) received from outside (so-called network standby setting) is enabled.

As shown in FIG. 8, first, when the first device 20-1 receives a power on command (YES in step S101), the first device 20-1 switches itself from the standby state to the normal state (S102). The power on command is inputted in response to an operation on the power button 241 or the remote controller 27 (see FIG. 3).

Specifically, the control unit 21 of the first device 20-1, in which the network CPU monitors the reception of a power on command, starts up the host CPU when a power on command is received. Thus, the control unit 21 switches the device from the standby state to the normal state. With this, the control unit 21 of the first device 20-1 also switches the main playback unit 30-1 from the standby state to the normal state.

Next, the first device 20-1 transmits a number-of-playback-units confirmation command (getFeatures) for inquiring about the number of content playback units 30 of the second device 20-2, to the second device 20-2 (S103). The second device 20-2, having received the number-of-playback-units confirmation command, sends back the number of content playback units 30 (number of zones) of the device itself to the first device 20-1 (S201). In this example, the second device 20-2 has four content playback units 30 in total, that is, the main playback unit 30-1 and the zone playback units 30-2 to 30-4, and therefore sends back four values to the first device 20-1. The transmission of the number-of-playback-units confirmation command (S103) and the sending back of the number of zones (S201) may be carried out in advance before the switching to the standby state, for example, the first time a link state is formed, or the like.

Next, the first device 20-1 transmits a playback unit status confirmation command (getStatus) for inquiring the status of the inputs to the content playback units 30 of the second device 20-2, to second device 20-2 (S104). The playback unit status confirmation command is generated for each of the content playback units 30, based on the number of content playback units 30 acquired in response to the number-of-playback-units confirmation command. In this example, four playback unit status confirmation commands in total, corresponding to each of the main playback unit 30-1 and the zone playback units 30-2 to 30-4 of the second device 20-2, are generated and transmitted to the second device 20-2.

The second device 20-2, having received the playback unit status confirmation commands, refers to the management table (see FIG. 5) held by the device itself, and sends back values expressing the inputs to the content playback units 30 of the device itself, to the first device 20-1. In this example, for the main playback unit 30-1 and the third zone playback unit 30-3, a value (MC Link) expressing that a link state is to be formed with the master device is sent back. For the second zone playback unit 30-2, a value expressing an HDMI input is sent back. For the fourth zone playback unit 30-4, a value expressing an audio input is sent back.

Next, the first device 20-1 transmits, to the second device 20-2, a state control command (setPower) for a content playback unit 30 which is able to form a link state, of the content playback units 30 of the second device 20-2 (S105). The state control command is generated for the content playback unit 30 for which the value (MC Link) expressing that a link state is to be formed with the master device is set, based on the values expressing the inputs to the content playback units 30 of the second device 20-2 acquired in response to the playback unit status confirmation commands. In this example, the state control command for the main playback unit 30-1 and the third zone playback unit 30-3 is generated and transmitted to the second device 20-2.

The second device 20-2, having received the state control command, switches itself from the standby state to the normal state and also switches the content playback units 30 designated by the state control command, from the standby state to the normal state (S203).

Specifically, the control unit 21 of the second device 20-2, in which the network CPU monitors the reception of a state control command, starts up the host CPU when a state control command is received. Thus, the control unit 21 switches the device from the standby state to the normal state. The control unit 21 of the second device 20-2 also switches the content playback unit 30 designated by the state control command, from the standby state to the normal state. In this example, the main playback unit 30-1 and the third zone playback unit 30-3 are switched from the standby state to the normal state.

Thus, both of the first device 20-1 and the second device 20-2, set to forma link state, switch from the standby state to the normal state and form a link state again. That is, the first device 20-1 and the second device 20-2 are enabled to carry out collaborative playback.

Next, as shown in FIG. 9, the first device 20-1 determines whether any of the zone playback units 30-2, 30-3 of the device itself synchronizes with the main playback unit 30-1 or not (S106). Specifically, the first device 20-1 determines whether a value (Main Sync) expressing that the unit is to synchronize with the main playback unit 30-1 is set for the inputs to the zone playback units 30-2, 30-3 or not, referring to the management table (see FIG. 6) held by the device itself.

If one or both of the zone playback units 30-2, 30-3 synchronize with the main playback unit 30-1 (YES in step S106), the first device 20-1 switches the zone playback unit (s) 30-2, 30-3 set to synchronize with the main playback unit 30-1 from the standby state to the normal state (S107, an example of the function of a state switching unit). In this example, both of the zone playback units 30-2, 30-3 are switched from the standby state to the normal state. This enables collaborative playback by the main playback unit 30-1 and the zone playback units 30-2, 30-3 of the first device 20-1.

Subsequently, the first device 20-1 starts playing back content and also starts distributing content data to the second device 20-2 (S108). When the distribution of content data is started, the second device 20-2 starts playing back the content, too (S204). Thus, collaborative playback by the first device 20-1 and the second device 20-2 is implemented. In this example, the main playback unit 30-1 and the zone playback units 30-2, 30-3 of the first device 20-1, and the main playback unit 30-1 and the zone playback unit 30-3 of the second device 20-2 carryout collaborative playback.

Here, the content which the first device 20-1 starts playing back is content designated in advance in the client list (see FIG. 4). If a setting to automatically play back content when switching from the standby state to the normal state (automatic playback setting) is enabled and content is designated in the client list, the first device 20-1 starts playing back the content in step S108. Meanwhile, if the automatic playback setting is disabled or content is not designated in the client list, the first device 20-1 waits without playing back any content and still forming a link state, after the end of step S107.

Next, if the first device 20-1 receives a power off command (YES in step S109), the first device 20-1 transmits a state control command (setPower) to switch from the normal state to the standby state, to the second device 20-2 (S110), and switches itself from the normal state to the standby state (S111). The power off command, too, is inputted in response to an operation on the power button 241 or the remote controller 27 (see FIG. 3).

Specifically, the control unit 21 of the first device 20-1 stops the operation of the host CPU when the power off command is received. Thus, the control unit 21 switches the first device 20-1 from the normal state to the standby state. With this, the main playback unit 30-1 and the zone playback units 30-2, 30-3 of the first device 20-1 switch from the normal state to the standby state, too.

The second device 20-2, having receives the state control command to switch from the normal state to the standby state, switches itself from the normal state to the standby state (S205).

Specifically, the control unit 21 of the second device 20-2 stops the operation of the host CPU when the state control command is received. Thus, the control unit 21 switches the second device 20-2 from the normal state to the standby state. With this, the main playback unit 30-1 and the zone playback units 30-2 to 30-4 of the second device 20-2 switch from the normal state to the standby state, too.

Thus, both of the first device 20-1 and the second device 20-2, which are set to form a link state, switch from the normal state to the standby state.

The client state link setting will be described below. The client state link setting is a setting on whether or not to link the state of a client device with the state of the master device when the first device 20-1, which is the master device, switches between the standby state and the normal state.

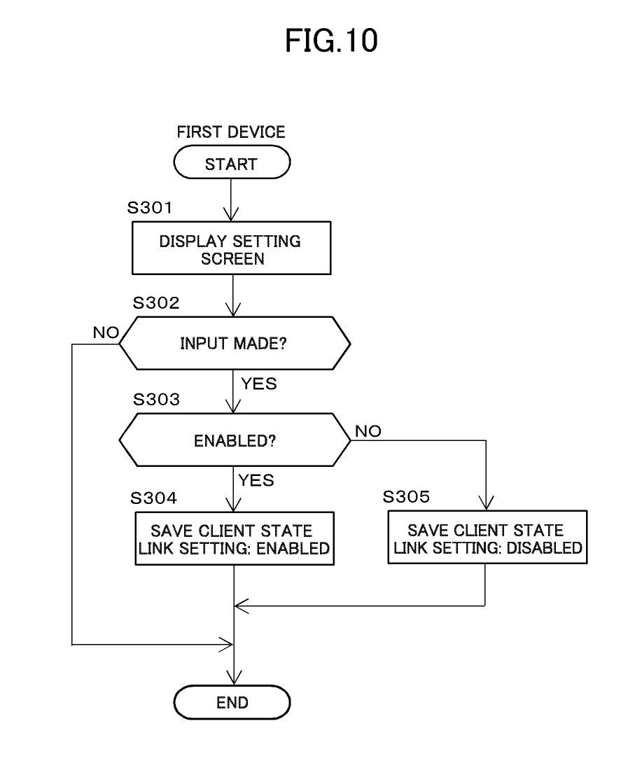

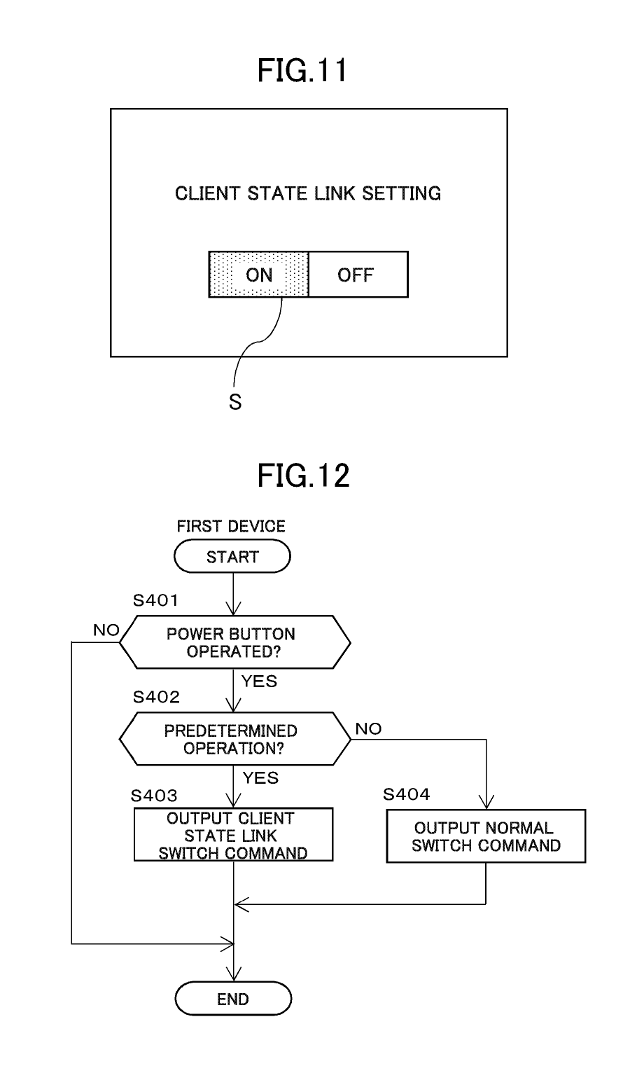

As shown in FIG. 10, first, the first device 20-1 displays a setting screen for setting whether to enable or disable the client state link setting, on the display unit 25 or an external display device (S301). As shown in FIG. 11, for example, a switch S to accept a switching between enabling and disabling the client state link setting is displayed on the setting screen.

If an input is made on the setting screen (YES in step S302) and the input corresponds to enabling (YES in step S303), the first device 20-1 saves the client state link setting as enabled (S304, an example of a second setting). Meanwhile, if the input corresponds to disabling (NO in step S303), the first device 20-1 saves the client state link setting as disabled (S305, an example of a first setting).

If the client state link setting is enabled, when the first device 20-1, which is the master device, switches between the standby state and the normal state, a state control command is transmitted to the second device 20-2, which is a client device, and the second device 20-2, which is a client device, switches between the standby state and the normal state, as described above (see FIGS. 8 and 9). Meanwhile, if the client state link setting is disabled, only the first device 20-1 switches between the standby state and the normal state.

The enabling/disabling of the client state link setting may be described in the client list (see FIG. 4). When switching between the standby state and the normal state, the first device 20-1 may read out the client state link setting in the client list. If the client state link setting is enabled, the first device 20-1 may transmit a state control command to the second device 20-2, which is a client device, so as to switch the second device 20-2 between the standby state and the normal state.

Next, a modification example will be described. In the modification example, whether to link the state of a client device or not is switched according to the manner of operation of the power button of the first device 20-1, which is the master device.

As shown in FIG. 12, if the power button 241 (see FIG. 3) of the first device 20-1 is operated (YES in step S401) and the operation is a predetermined operation (YES in step S402), the first device 20-1 outputs a client state link switch command (S403, an example of a second command). Meanwhile, if the operation is not the predetermined operation (NO in step S402), the first device 20-1 outputs a normal switch command (S404, an example of a first command).

If a client state link switch command is outputted, when the first device 20-1, which is the master device, switches between the standby state and the normal state, a state control command is transmitted to the second device 20-2, which is a client device, and the second device 20-2, which is a client device, switches between the standby state and the normal state, as described above (see FIGS. 8 and 9). Meanwhile, if a normal switch command is outputted, only the first device 20-1 switches between the standby state and the normal state.

Here, the manner of operation of the power button 241 is operated may be, for example, the press time of the power button 241. If the press time is relatively short, a normal switch command may be outputted. If the pressing time is relatively long, a client state link switch command may be outputted. The manner of operation of the power button 241 may also be, for example, a combination of the power button 241 and another button or the like. If only the power button 241 is pressed, a normal switch command may be outputted. If the power button 241 is pressed simultaneously with another button, a client state link switch command may be outputted.

The processing shown in FIG. 12 is not limited to the first device 20-1 and may be executed on the remote controller 27 (see FIG. 3). That is, if an operation on the power button of the remote controller 27 is a predetermined operation (YES in step S402), the remote controller 27 may output a client state link switch command to the first device 20-1 (S403). If the operation is not the predetermined operation (NO in step S402), the remote controller 27 may output a normal switch command to the first device 20-1 (S404).

An embodiment of the invention has been described above. However, the invention is not limited to the embodiment. A person skilled in the art can think of various modifications.

What is claimed is:

1. A content playback device comprising:
a link state forming unit which forms a link state so that a content playback device that is a master device distributes content data to another content playback device that is a client device and so that the content playback device and the another content playback device collaboratively play back content;
an identification information acquisition unit which acquires device identification information of the another content playback device; and
a command transmission unit which transmits a state control command to switch the another content playback device between an inactive state and an active state to the another content playback device, using the device identification information, when the content playback device switches between an inactive state and an active state.

2. The content playback device according to claim 1, wherein
the another content playback device comprises one or a plurality of content playback units that can individually switch between an inactive state and an active state, and
the command transmission unit transmits the state control command for a content playback unit selected from the one or plurality of content playback units, to the another content playback device.

3. The content playback device according to claim 2, wherein
the command transmission unit
transmits, to the another content playback device, a playback unit status confirmation command for inquiring about whether each of the content playback units is able to form the link state or not, and
transmits the state control command for a content playback unit that is able to form the link state, to the another content playback device.

4. The content playback device according to claim 3, wherein
the command transmission unit
transmits, to the another content playback device, a number-of-playback-units confirmation command for inquiring about a number of the content playback units of the another content playback device, and
transmits the playback unit status confirmation command for each of the content playback units, to the another content playback device.

5. The content playback device according to claim 1, further comprising:
first and second content playback units which can individually switch between an inactive state and an active state; and
a state switching unit which switches the second content playback unit between an inactive state and an active state when the first content playback unit switches between an active state and an active state, if a setting for the first content playback unit and the second content playback unit to collaboratively play back content is given.

6. The content playback device according to claim 1, wherein
a switching can be made between
a first setting in which only the content playback device switches between an inactive state and an active state, and
a second setting in which the state control command is transmitted to the another content playback device when the content playback device switches between an inactive state and an active state.

7. The content playback device according to claim 1, wherein
a first command to switch only the content playback device between an inactive state and an active state, or
a second command to transmit the state control command to the another content playback device when the content playback device switches between an inactive state and an active state
is accepted from a command generation unit which selectively generates the first command or the second command according to a manner of operation of a power button.

8. The content playback device according to claim 7, further comprising
the command generation unit.

9. The content playback device according to claim 1, wherein
the content playback device and the another content playback device simultaneously play back common content.

10. A method comprising:
causing a first content playback device to acquire device identification information of a second content playback device;
causing the first content playback device to transmit a state control command to switch the second content playback device between an inactive state and an active state to the second content playback device, using the device identification information, when the first content playback device switches between an inactive state and an active state; and
forming a link state so that the first content playback device, which is a master device, distributes content data to the second content playback device, which is a client device, and so that the first content playback device and the second content playback device collaboratively play back content.

11. The method according to claim 10, wherein
the second content playback device comprises one or a plurality of content playback units that can individually switch between an inactive state and an active state, and
the transmitting includes transmitting the state control command for a content playback unit selected from the one or plurality of content playback units, to the second content playback device.

12. The method according to claim 11, wherein
the transmitting includes:
transmitting, to the second content playback device, a playback unit status confirmation command for inquiring about whether each of the content playback units is able to form the link state or not; and
transmitting the state control command for a content playback unit that is able to form the link state, to the second content playback device.

13. The method according to claim 12, wherein
the transmitting includes:
transmitting, to the second content playback device, a number-of-playback-units confirmation command for inquiring about a number of the content playback units of the second content playback device; and
transmitting the playback unit status confirmation command for each of the content playback units, to the second content playback device.

14. The method according to claim 10, wherein
the first content playback device comprises first and second content playback units which can individually switch between an inactive state and an active state, and
the method further includes switching the second content playback unit between an inactive state and an active state when the first content playback unit switches between an active state and an active state, if a setting for the first content playback unit and the second content playback unit to collaboratively play back content is given.

15. The method according to claim 10, wherein
a switching can be made between
a first setting in which only the first content playback device switches between an inactive state and an active state, and
a second setting in which the state control command is transmitted to the second content playback device when the first content playback device switches between an inactive state and an active state.

16. The method according to claim 10, wherein
the first content playback device accepts
a first command to switch only the first content playback device between an inactive state and an active state, or
a second command to transmit the state control command to the second content playback device when the first content playback device switches between an inactive state and an active state
from a command generation unit which selectively generates the first command or the second command according to a manner of operation of a power button.

17. The method according to claim 16, wherein
the first content playback device comprises the command generation unit.

18. The method according to claim 10, wherein
the first content playback device and the second content playback device simultaneously play back common content.

19. A content playback method comprising:
forming a link state so that a first content playback device, which is one component of a content playback system and a master device, distributes content data to a second content playback device, which is one component of the content playback system and a client device, and so that the first content playback device and the second content playback device collaboratively play back content; and
causing the first content playback device to transmit, to the second content playback device, a state control command to switch a state of the second content playback device between an inactive state and an active state when a state of the first content playback device switches between an inactive state and an active state.

20. The content playback method according to claim 19 further comprising:
causing an identification information acquisition unit, which is one component of the first content playback device, to acquire device identification information of the second content playback device, and
causing the command transmission unit to transmit the state control command to the second content playback device, using the device identification information.
